(19) United States
(12) Patent Application Publication
(10) Pub. No.: US 2026/0288760 A1
(43) Pub. Date: Sep. 24, 2026

(54) INTELLIGENT WELL COMPLETION OPTIMIZATION DESIGN METHOD AND APPARATUS BASED ON MULTI-OBJECTIVE OPTIMIZATION

(71) Applicant: CHINA UNIVERSITY OF PETROLEUM—BEIJING, Beijing (CN)

(72) Inventors: Mao SHENG, Beijing (CN); Shimeng HU, Beijing (CN); Gensheng LI, Beijing (CN); Shouceng TIAN, Beijing (CN); Yuqing CHEN, Beijing (CN); Tianyu WANG, Beijing (CN); Bingbing LIU, Beijing (CN); Qinzhuo LIAO, Beijing (CN)

(73) Assignee: CHINA UNIVERSITY OF PETROLEUM—BEIJING, Beijing (CN)

(21) Appl. No.: 19/539,044

(22) Filed: Feb. 13, 2026

(30) Foreign Application Priority Data
Mar. 24, 2025 (CN) 202510348319.1

(51) Int. Cl. G06F 16/28; G06F 16/355; G06F 18/23213

(52) U.S. Cl. CPC G06F 16/285; G06F 16/355; G06F 18/23213

(57) ABSTRACT

An intelligent well completion optimization design method and apparatus based on multi-objective optimization, where the method includes: clustering a first dataset according to a weighted clustering model, and evaluating geological sweet spots of clustered clusters to obtain a geological sweet spot evaluation result, where the first dataset includes reservoir petrophysical parameters along a horizontal well depth, and the weighted clustering model is constructed according to weights of the reservoir petrophysical parameters; dividing a fracturing segment according to an engineering sweet spot evaluation result and a preset segment length constraint, where the engineering sweet spot evaluation result is determined according to a geomechanical parameter; solving a multi-objective function constructed according to the geological sweet spot evaluation result, the engineering sweet spot evaluation result and a preset cluster spacing constraint within the divided fracturing segment, and performing a well completion optimization design according to an objective solution result of the multi-objective function.

### CROSS-REFERENCE TO RELATED APPLICATIONS

This application claims priority to Chinese Patent Application No. 202510348319.1, filed on Mar. 24, 2025, which is hereby incorporated by reference in its entirety.

### BACKGROUND

### Technical Field

The present application relates to the technical field of reservoir production enhancement and transformation, and in particular, to an intelligent well completion optimization design method and apparatus based on multi-objective optimization.

### Description of Related Art

Refined and intelligent well completion optimization design is crucial for the development and transformation of unconventional oil reservoirs.

However, existing technologies require significant manpower and time costs to interpret a clustering result when using a clustering algorithm to identify and evaluate sweet spots, thereby limiting the ability to optimize well completion design based on the sweet spots. Moreover, existing technologies mostly adopt geometric or single well completion design methods, making it difficult to achieve balanced fracturing transformation. That is, the existing well completion optimization design methods suffer from problems such as low intellectualization and efficiency, poor design effect, and difficulty in achieving balanced fracturing transformation.

Regarding the above-mentioned problems, an effective solution has not yet been proposed.

### SUMMARY

The embodiments in this specification provide an intelligent well completion optimization design method and apparatus based on multi-objective optimization, so as to solve the problems in the existing well completion optimization design methods, such as low intellectualization and efficiency, poor design effect, difficulty in achieving balanced fracturing transformation, etc.

In a first aspect, an embodiment of this specification provides an intelligent well completion optimization design method based on multi-objective optimization, including:
clustering a first dataset according to a weighted clustering model, and evaluating geological sweet spots of clustered clusters to obtain a geological sweet spot evaluation result, where the first dataset includes reservoir petrophysical parameters along a horizontal well depth, and the weighted clustering model is constructed according to weights of the reservoir petrophysical parameters;
dividing a fracturing segment according to an engineering sweet spot evaluation result and a preset segment length constraint, where the engineering sweet spot evaluation result is determined according to a geomechanical parameter; and
solving a multi-objective function constructed according to the geological sweet spot evaluation result, the engineering sweet spot evaluation result and a preset cluster spacing constraint within the divided fracturing segment, and performing a well completion optimization design according to an objective solution result of the multi-objective function.

In some embodiments, the method further includes:
calculating correlation coefficients between the reservoir petrophysical parameters and oil production profile data;
determining a sum of absolute values of the correlation coefficients between the reservoir petrophysical parameters and the oil production profile data; and
determining weights of the reservoir petrophysical parameters according to the correlation coefficients between the reservoir petrophysical parameters and the oil production profile data as well as the sum of absolute values of the correlation coefficients.

In some embodiments, the weighted clustering model is constructed according to the weights of the reservoir petrophysical parameters, which includes:
constructing a weighted Euclidean distance function, a criterion function and a rating function according to the weights of the reservoir petrophysical parameters; and
constructing the weighted clustering model according to the weighted Euclidean distance function, the criterion function and the rating function.

In some embodiments, clustering the first dataset according to the weighted clustering model includes:
selecting a preset quantity of clustering centers from the first dataset;
calculating weighted Euclidean distances from first sample points in the first dataset to the clustering centers according to the weighted Euclidean distance function, where the first sample points correspond to the reservoir petrophysical parameters at different horizontal well depths;
comparing the weighted Euclidean distances, and according to a comparison result dividing the first sample points into a corresponding clustering set where the weighted Euclidean distances are less than a preset distance threshold value;
selecting a new clustering center from the clustering set according to the criterion function;
repeating the processes of calculating the weighted Euclidean distances, dividing the first sample points and selecting the new clustering center until a quantity of iterations reaches a preset iteration-quantity threshold or a newly selected clustering center remains unchanged, to obtain a clustered first clustering result.

Evaluating the geological sweet spots of the clustered clusters to obtain the geological sweet spot evaluation result, includes:
evaluating the geological sweet spots clustered in the first clustering result through the rating function to obtain the geological sweet spot evaluation result.

In some embodiments, evaluating the geological sweet spots clustered in the first clustering result through the rating function to obtain the geological sweet spot evaluation result includes:
determining weighted geological sweet spot indexes of the clusters in the first clustering result through the rating function;
comparing the weighted geological sweet spot indexes of the clusters, and ranking a comparison result of the weighted geological sweet spot indexes in a descending order, to obtain a ranking result of the weighted geological sweet spot indexes; and rating corresponding geological sweet spots into different levels according to the ranking result of the weighted geological sweet spot indexes, so as to obtain the geological sweet spot evaluation result, where the geological sweet spot evaluation result includes a geological sweet spot category label.

In some embodiments, the engineering sweet spot evaluation result includes a geomechanical strength along the horizontal well depth; and accordingly, dividing the fracturing segment according to the engineering sweet spot evaluation result and the preset segment length constraint includes:
constructing a second dataset according to the geomechanical strength along the horizontal well depth and a well depth, where second sample points in the second dataset correspond to different well depths and geomechanical strengths at different horizontal well depths;
constructing a geomechanical similarity item according to the geomechanical strengths of the second sample points and an average geomechanical strength of all second sample points;
constructing a segment length penalty term according to a well depth range of the fracturing segment and the preset segment length constraint;
constructing an objective function dividing the fracturing segment according to the geomechanical similarity term and the segment length penalty term;
solving the objective function by using a dynamic programming algorithm to determine a segmentation point of the fracturing segment; and
dividing the fracturing segment according to the segmentation point to obtain a fracturing segment division result, where the fracturing segment division result includes a segment label.

In some embodiments, the method further includes:
determining a geological sweet spot weight according to the geological sweet spot category label in the geological sweet spot evaluation result;
identifying the fracturing segment according to the segment label in the fracturing segment division result and imposing a constraint on a fracturing cluster within the fracturing segment, so that the fracturing cluster after the constraint is imposed is located within a preset segment depth range;
generating a candidate area according to the geomechanical strength along the horizontal well depth, and generating a candidate cluster from the candidate area;
taking a sum of geological sweet spot weights being greater than a preset weight threshold as a first objective, taking the geomechanical similarity item being less than a preset variance threshold as a second objective, and taking the preset cluster spacing constraint as a constraint condition; and
constructing the multi-objective function based on the first objective, the second objective, and the constraint condition.

In some embodiments, solving the multi-objective function constructed according to the geological sweet spot evaluation result, the engineering sweet spot evaluation result and the preset cluster spacing constraint includes:
solving the multi-objective function through a multi-objective optimization algorithm, and determining the objective solution result of the multi-objective function from the candidate cluster.

Performing the well completion optimization design according to the objective solution result of the multi-objective function includes:
taking the objective solution result as an objective design scheme of the fracturing cluster in the fracturing segment, and performing a well completion optimization design according to the objective design scheme of the fracturing cluster.

In a second aspect, an embodiment of this specification also provides an intelligent well completion optimization design apparatus based on multi-objective optimization, including:
a geological sweet spot evaluation module, configured to cluster a first dataset according to a weighted clustering model, and evaluate geological sweet spots of clustered clusters to obtain a geological sweet spot evaluation result, where the first dataset includes reservoir petrophysical parameters along a horizontal well depth, and the weighted clustering model is constructed according to weights of the reservoir petrophysical parameters;
a fracturing segment division module, configured to divide a fracturing segment according to an engineering sweet spot evaluation result and a preset segment length constraint, where the engineering sweet spot evaluation result is determined according to a geomechanical parameter; and
a well completion optimization design module, configured to solve a multi-objective function constructed according to the geological sweet spot evaluation result, the engineering sweet spot evaluation result and a preset cluster spacing constraint within the divided fracturing segment, and perform a well completion optimization design according to an objective solution result of the multi-objective function.

In a third aspect, an embodiment of this specification further provides a computer-readable storage medium, storing computer program instructions which, when executed by a processor, implement the steps of the intelligent well completion optimization design method based on multi-objective optimization described above.

The embodiments of this specification provide an intelligent well completion optimization design method and apparatus based on multi-objective optimization. Firstly, the first dataset is clustered according to the weighted clustering model, and the geological sweet spots of the clustered clusters are evaluated to obtain the geological sweet spot evaluation result, where the first dataset includes the reservoir petrophysical parameters along the horizontal well depth, and the weighted clustering model is constructed according to the weights of the reservoir petrophysical parameters. Then, the fracturing segment is divided according to the engineering sweet spot evaluation result and the preset segment length constraint, where the engineering sweet spot evaluation result is determined according to the geomechanical parameter. Finally, within the divided fracturing segment, the multi-objective function constructed according to the geological sweet spot evaluation result, the engineering sweet spot evaluation result, and the preset cluster spacing constraint is solved, and the well completion optimization design is performed according to the objective solution result of the multi-objective function. In the embodiments of this specification, by introducing the weighted clustering model, it is possible to achieve the intelligent evaluation of the geological sweet spots without incurring significant manpower and time costs to interpret the clustering results. By means of the geomechanical parameter, the engineering sweet spot evaluation can be accurately performed to determine the engineering sweet spot evaluation result, and by combining with the preset segment length constraint, the intelligent design for the fracturing segment can be achieved, thereby solving the problem of non-balanced fracturing caused by the traditional design methods that adopt geometry or single fracturing segment spacing. By solving the multi-objective function, the intelligent and refined well completion optimization design can be achieved, thereby improving the engineering applicability.

### BRIEF DESCRIPTION OF DRAWINGS

In order to illustrate technical solutions in embodiments of the present application or the prior art more clearly, the accompanying drawings required for the description of the embodiments or the prior art will be briefly described in the below. Obviously, the accompanying drawings described below are merely some embodiments of present application, and for those ordinary skilled in the art, other accompanying drawings may be obtained based on these accompanying drawings without any creative effort.

FIG. 1 is a schematic flowchart of an intelligent well completion optimization design method based on multi-objective optimization according to an embodiment of this specification.

FIG. 2 is a schematic diagram of an embodiment of applying an intelligent well completion optimization design method based on multi-objective optimization according to an embodiment of this specification in a scenario example.

FIG. 3 is a structural composition schematic diagram of an intelligent well completion optimization design apparatus based on multi-objective optimization according to an embodiment of this specification.

FIG. 4 is a schematic structural composition diagram of an electronic device according to an embodiment of this specification.

### DETAILED DESCRIPTION OF EMBODIMENTS

In order to enable those skilled in the art to better understand the technical solutions in this specification, the technical solutions in the embodiments of this specification will be clearly and comprehensively described in the below in conjunction with the accompanying drawings in the embodiments of this specification. Obviously, the described embodiments are merely part of rather than all of the embodiments of this specification. All other embodiments obtained by those ordinary skilled in the art based on the embodiments in this specification without any creative efforts shall belong to the protection scope of this specification.

Unconventional oil and gas resources dominated by shale are playing an increasingly important role in energy supply. Multi-stage hydraulic fracturing is a key technology for developing the unconventional reservoirs, and implementing an effective well completion design plays a crucial role in the development and transformation of the unconventional reservoirs, with the goal of achieving balanced production increase in each fracturing segment. A prerequisite for effective fracturing design is to accurately evaluate sweet spot areas (areas with favorable geological and engineering characteristics). Identifying these sweet spots and optimizing well completion design are essential for targeting high-quality reservoirs and achieving uniform fracture initiation and propagation.

The concept of “sweet spot” is widely applied in oil and gas exploration and development, and may include a geological sweet spot and an engineering sweet spot. The geological sweet spot refers to an area with high hydrocarbon content and good rock physical characteristics, and is generally evaluated by using parameters such as clay content, total organic carbon, porosity, and permeability. The engineering sweet spots refers to an area that is conducive to efficient hydraulic fracturing, and is evaluated based on geomechanical indicators such as Young's modulus, Poisson's ratio, and in-situ stress. However, the strong non-linear relationship and complexity of these parameters makes it challenging to discern their relative importance.

At present, there is limited research on the comprehensive consideration of the geological engineering “double sweet spot” and their application to the well completion design. In these researches, a common method includes using a method such as a single-factor evaluation method, a multi-factor correlation analysis method, or a radar area model to determine an optimal parameter classification threshold value, so as to construct a coupled classification array of the geological sweet spot and the engineering sweet spot, thereby forming a comprehensive evaluation table of the “double sweet spot”. On the basis of this evaluation table, a quantity of perforation clusters (also known as fracturing clusters) increases during a fracturing segment favorable for the “double sweet spot”, while the perforation clusters become sparse in a fracturing segment unfavorable for the “double sweet spot”. However, this method has a significant limitation in evaluating and balancing the geological sweet spot and engineering sweet spot. On one hand, these classification thresholds tend to differ due to the selected method and reservoir characteristics, thereby posing challenges such as non-uniqueness and limited regional applicability. On the other hand, although a cluster density is increased in the high-quality “double sweet spot” fracturing segment, a geometric or single design is used to locate the clusters in each fracturing segment without considering changes in the initiation pressure of inter cluster fractures. An increasing amount of monitoring data indicates that conventional geometric or single well completion designs are difficult to achieve balanced fracturing transformation.

With the application of artificial intelligence in oil and gas exploration and development, a clustering algorithm has become a promising sweet spot recognition method. However, it is difficult to distinguish and integrate the geological sweet spot and the engineering sweet spot, and requires a lot of effort in combination with mechanism cognition to interpret the clustering result, which limits its capability of comprehensively considering the “double sweet spot” in the well completion optimization design.

In summary, existing well completion optimization design methods have problems such as low intellectualization and efficiency, poor design effect, and difficulty in achieving balanced fracturing transformation.

In order to solve the above problems, the embodiments of this specification provide an intelligent well completion optimization design method and apparatus based on multi-objective optimization. Firstly, a first dataset is clustered according to a weighted clustering model, and the geological sweet spots of clustered cluster are evaluated so as to obtain a geological sweet spot evaluation result, where the first dataset includes various reservoir petrophysical parameters along a horizontal well depth, and the weighted clustering model is constructed according to weights of the reservoir petrophysical parameters. Then, a fracturing segment is divided according to an engineering sweet spot evaluation result and a preset segment length constraint, where the engineering sweet spot evaluation result is determined according to a geomechanical parameter. Finally, within the divided fracturing segment, a multi-objective function constructed according to the geological sweet spot evaluation result, the engineering sweet spot evaluation result, and a preset cluster spacing constraint is solved, and a well completion optimization design is performed according to an objective solution result of the multi-objective function.

By introducing the weighted clustering model, it is possible to achieve the intelligent evaluation of the geological sweet spots, without incurring significant manpower and time costs in interpretation of the clustering results. By means of the geological mechanical parameters, the engineering sweet spot evaluation can be accurately performed to determine the engineering sweet spot evaluation result, and by combining with the preset segment length constraint, the intelligent design for the fracturing segment can be achieved, thereby solving the problem of non-balanced fracturing caused by the traditional design methods that rely on geometry or single fracturing segment spacing. By solving the multi-objective function, the intelligent and refined well completion optimization design can be achieved, thereby improving the engineering applicability.

It should be noted that terms such as “first” and “second” in the specification and claims of the present application are used to distinguish similar objects, and are not necessarily used to describe a specific sequence or order. It should be understood that the data used in this way may be interchanged in appropriate circumstances for the embodiments of the present application described herein.

It can be understood that the above-mentioned method provided in the embodiments of this specification can be applied to an electronic device, which may refer to an electronic device with calculation, processing and storage capabilities of data. The electronic device may be a terminal such as a PC (Personal Computer), a tablet computer, a smart phone, a wearable device, or a smart robot, etc. The electronic device may also be a server. The server may be an independent physical server, may also be a server cluster or a distributed system formed by a plurality of physical servers, and may also be a cloud server providing cloud computing services.

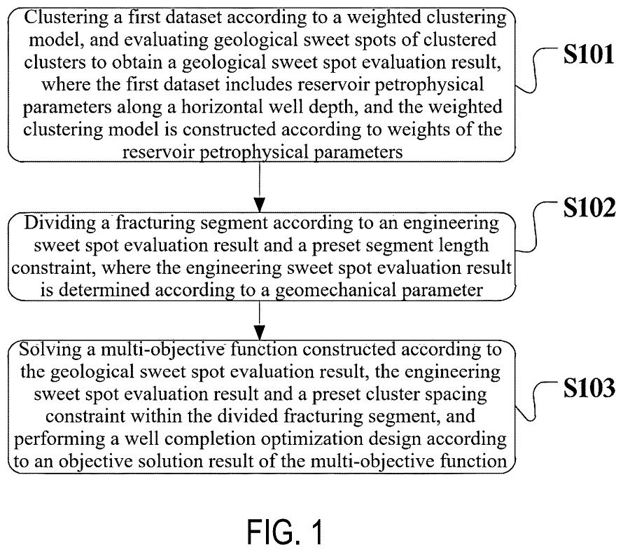

Referring to FIG. 1, an embodiment of this specification provides an intelligent well completion optimization design method based on multi-objective optimization. In a specific implementation, the method may include the contents in the below.

S101: clustering a first dataset according to a weighted clustering model, and evaluating geological sweet spots of clustered clusters to obtain a geological sweet spot evaluation result, where the first dataset includes reservoir petrophysical parameters along a horizontal well depth, and the weighted clustering model is constructed according to weights of the reservoir petrophysical parameters.

In some embodiments, before the above-mentioned S101, readily available and valuable data during the drilling, well completion and production processes may be collected in advance, such as logging data, drilling data as well as post-fracturing monitoring data. The logging data may include, but is not limited to, gamma-ray logging (GR), density logging (DEN), acoustic logging (DT), compensated neutron logging (CNL), and resistivity logging (RT). The drilling data may include, but is not limited to, weight-on-bit (WOB), torque (T), rotational speed (N), rate of penetration (ROP), and bit diameter (Ab). The monitoring data may include, but is not limited to, oil production profile data obtained through tracer diagnosis and fluid distribution data obtained through optical fiber monitoring.

Due to that the quality of collected data has a significant impact on the performance of subsequently constructed models and algorithms, and original data generally contains discontinuities and abnormalities caused by, for example, environmental factors, instrument performance, and human errors, it is required to perform data pre-processing on the collected data. The data pre-processing may include: using a KNN algorithm to fill outliers and missing values in the collected data, unifying the accuracies of the logging and drilling data to 0.125 m, etc., and there is no specific limitation on this in this specification.

Afterwards, the reservoir petrophysical parameter and the geomechanical parameter may be calculated according to the pre-processed drilling data and/or logging data, and specific calculation formulas can refer to the prior art, and will not be repeated herein. The reservoir petrophysical parameter may include at least one of the following: shale content, porosity, oil saturation and permeability. The geomechanical parameter may include at least one of the following: bottomhole mechanical specific energy and minimum horizontal principal stress. The reservoir petrophysical parameter can be used to evaluate the geological sweet spot, while the geomechanical parameter can be used to evaluate an engineering sweet spot. The reservoir petrophysical parameter and the geomechanical parameter can be stored in an ascending order of well depth, with an interval of 0.125m. The reservoir petrophysical parameter and the geomechanical parameter can effectively characterize the flow capacity, storage performance and mechanical properties of the reservoir, and can be calculated from oilfield logging and drilling data without the need for a special logging procedure, thereby ensuring practical applicability for large-scale field implementation.

Afterwards, in order to reduce noise and improve the reliability of subsequent clustering evaluation, the denoising and smoothing processing may be performed on the reservoir petrophysical parameter and the geomechanical parameter.

For example, since curves of the reservoir petrophysical parameters all represent spatially ordered data along a wellbore depth, and a depth axis is comparable to a time series, the denoising processing on the reservoir petrophysical parameter may be performed by means of empirical mode decomposition (EMD), and the specific processing process thereof is shown as below:
1) IMF extraction: iteratively extracting a signal extreme envelope to generate IMF components with frequencies ranging from high to low;
2) Noise component identification: calculating sample entropy values of first two-order IMFs, and if the entropy value exceeds a threshold of 1.2, determining it as a noise dominant component;
3) Signal reconstruction: after removing noise IMF, superposing the remaining IMFs and a residual term to obtain a denoised reservoir petrophysical parameter.

The normalization processing is then performed on the reservoir petrophysical parameter after the denoising processing, and reference may be made to the prior art for details, which will not be repeated herein. By using a normalization method, the reservoir petrophysical parameter can be converted into a standard normal distribution with a mean value of 0 and a standard deviation of 1, thereby eliminating the influence of different parameter dimensions on the data while maintaining the data distribution characteristics unchanged.

In some embodiments, before the above-mentioned S101, in a specific implementation, the method can further include:
calculating correlation coefficients between the reservoir petrophysical parameters and the oil production profile data;
determining a sum of absolute values of the correlation coefficients between the reservoir petrophysical parameters and the oil production profile data; and
determining weights of the reservoir petrophysical parameters according to the correlation coefficients between the reservoir petrophysical parameters and the oil production profile data as well as the sum of absolute values of the correlation coefficients.

Specifically, the first dataset X1 may be constructed first according to the reservoir petrophysical parameters along the horizontal well depth (such as: shale content Vₛₕ, porosity Φ, oil saturation So, permeability K):

$${X}_{1} = [ \begin{matrix}{x}_{11} & {x}_{12} & {x}_{13} & {x}_{14} \\ {x}_{21} & {x}_{22} & {x}_{23} & {x}_{24} \\ ⋮ & ⋮ & ⋮ & ⋮ \\ {x}_{n 1} & {x}_{n 2} & {x}_{n 3} & {x}_{n 4}\end{matrix} ] = [ \begin{matrix}{ϕ}_{1} & {K}_{1} & {So}_{1} & {V}_{sh 1} \\ {ϕ}_{2} & {K}_{2} & {So}_{2} & {V}_{sh 2} \\ ⋮ & ⋮ & ⋮ & ⋮ \\ {ϕ}_{n} & {K}_{n} & {So}_{n} & {V}_{shn}\end{matrix} ]$$

where, each row vector xᵢ corresponds to a vector of the reservoir petrophysical parameters (Φ, So, K, Vsh) for an i-th first sample point.

Then, a correlation analysis can be performed on the reservoir petrophysical parameters and the oil production profile data, and the correlation coefficients between the reservoir petrophysical parameters and the oil production profile data can be calculated. Since the relationship between the reservoir petrophysical parameters and the oil production profile data is generally nonlinear, a Spearman method can be selected to perform the correlation analysis on the reservoir petrophysical parameters after the denoising and smoothing processing as well as the oil production profile data in the monitoring data, to calculate Spearman correlation coefficients. The Spearman method is a non-parametric statistical method that can evaluate a monotonic relationship (linear or non-linear) without requiring a normality assumption, and is robust to outliers. Specifically, the correlation coefficients between the reservoir petrophysical parameters and the oil production profile data can be calculated according to the following formula:

$$ρ = 1 - \frac{6 \sum {d}_{j}^{2}}{n ( {n}^{2} - 1 )}$$

where, ρ is the correlation coefficient;

$${d}_{j}^{2}$$

is a rank difference between a j-th reservoir petrophysical parameter and an observed value of the oil production profile data; n is a quantity of first sample points. A determination method of the rank difference may be: ranking the reservoir petrophysical parameters and the oil production profile data, determining ranks of the ranked reservoir petrophysical parameters and ranks of the ranked oil production profile data, and then determining a rank difference between the reservoir petrophysical parameters and the observed value of the oil production profile data by calculating a difference therebetween.

The sum of the absolute values of the correlation coefficients between the reservoir petrophysical parameters and the oil production profile data may be determined according to the following formula:

$${\sum }_{j = 1}^{p} \vert {ρ}_{j} \vert$$

The weights of the reservoir petrophysical parameters may be determined according to the correlation coefficients between the reservoir petrophysical parameters and the oil production profile data as well as the sum of the absolute values of the correlation coefficients according to the following formula (assigning weights based on the absolute values of the correlation coefficients, and ensuring that a total weight of the reservoir petrophysical parameters is equal to 1):

$${w}_{j} = \frac{{ρ}_{j}}{{\sum }_{j = 1}^{p} \vert {ρ}_{j} \vert}$$

where, wⱼ is the weight of the j-th reservoir petrophysical parameter; ρⱼ is the correlation coefficient between the j-th reservoir petrophysical parameter and the oil production profile data; p is a total quantity of reservoir petrophysical parameters; |ρj| is the absolute value of the correlation coefficient of the j-th reservoir petrophysical parameter;

$${\sum }_{j = 1}^{p} \vert {ρ}_{j} \vert$$

is the sum of the absolute values of the correlation coefficients between the reservoir petrophysical parameters and the oil production profile data.

In some embodiments, the construction of the weighted clustering model in the above S101 is based on the weights of the reservoir petrophysical parameters, and, in a specific implementation, may include:
constructing a weighted Euclidean distance function, a criterion function and a rating function according to the weights of the reservoir petrophysical parameters; and
constructing the weighted clustering model according to the weighted Euclidean distance function, the criterion function and the rating function.

Specifically, the weighted Euclidean distance function may be constructed according to the following formula:

$$D ( {x}_{i} , {c}_{J} ) = \sqrt{{\sum }_{j = 1}^{p} \vert {w}_{j} \vert {( {x}_{ij} - {c}_{Jj} )}^{2}}$$

Where, D(xᵢ, c_{J}) is a weighted Euclidean distance, and may be taken as the weighted Euclidean distance function; xᵢ is a vector of the reservoir petrophysical parameters for an i-th first sample point; c_{J} is a centroid of a J-th cluster; p is a total quantity of reservoir petrophysical parameters; |wⱼ| is the absolute value of the weight of a j-th reservoir petrophysical parameter; xᵢⱼ is a vector of the j-th reservoir petrophysical parameter for an i-th first sample point; and c_{J} is a centroid of the j-th reservoir petrophysical parameter of the J-th cluster. The weighted Euclidean distance function can evaluate the distance between each first sample point and the corresponding clustering center within each clustering set. In order to enhance the impact of a key petrophysical parameter on the clustering process, the weighted Euclidean distance may be employed as a measure of inter-sample similarity.

The criterion function may be constructed according to the following formula:

$$WSSE = {\sum }_{j = 1}^{K} {\sum }_{{x}_{i} ∈ {C}_{j}} {\sum }_{j = 1}^{p} \vert {w}_{j} \vert {( {x}_{ij} - {c}_{Jj} )}^{2}$$

where, WSSE is a weighted sum of squared errors of K clusters, and may be taken as the criterion function; K is a preset total quantity of clusters; xᵢ is a vector of the reservoir petrophysical parameters for an i-th first sample point, and C_{J} represents all first samples belonging to a J-th cluster; p is a total quantity of the reservoir petrophysical parameters; |wⱼ| is the absolute value of the weight of a j-th reservoir petrophysical parameter; xᵢⱼ is the vector of the j-th reservoir petrophysical parameter for the i-th first sample point; c_{Jj} is a centroid of the j-th reservoir petrophysical parameter of the i-th cluster. K may be determined based on the “elbow rule”, and when K is lower than a suitable value, increasing K will significantly reduce WSSE, but when K exceeds the value, the decrease of WSSE is negligible, and then the value is the optimal K. The clustering effect may be evaluated through the criterion function.

The rating function may be constructed according to the following formula:

$${WGSSI}_{J} = {\sum }_{k ∈ \{ ϕ , S o , K , {V}_{s h} \}} {w}_{j} \cdot ( \frac{{p}_{Jj}^{25 \%} + {p}_{Jj}^{75 \%}}{2} )$$

where, WGSSIJ is a weighted geological sweet spot index of the cluster J, and may be taken as the rating function; Φ is porosity; So is the oil saturation; K is the permeability; Vₛₕ is the shale content; wⱼ is the weight of the j-th reservoir petrophysical parameter;

$${p}_{Jj}^{25 \%}$$

is a 25th percentile of the j-th reservoir petrophysical parameter in the J-th cluster; and

$${p}_{Jj}^{75 \%}$$

is a 75th percentile of the j-th reservoir petrophysical parameter in the J-th cluster. Where the horizontal well interval is divided into K distinct clusters, but their relative quality cannot be directly evaluated. In order to quantitatively evaluate reservoir quality and link the clustering results with mechanism cognition, the weighted geological sweet spot index (WGSSI) is proposed. This index integrates the weight derived from the correlation of the oil production contribution, so as to reflect the relative contribution of the petrophysical parameter to the reservoir performance. In order to minimize the impact of outliers, it is possible to analyze and focus on the interquartile range (i.e., 25th to 75th percentiles) of the normalized value of each reservoir petrophysical parameter within each clustering set. A higher WGSSIJ value indicates a better geological sweet spot and reservoir quality more favorable for production.

Afterwards, a mechanism-guided weighted K-medoids clustering model or algorithm can be constructed according to the weighted Euclidean distance function, the criterion function and the rating function, to achieve the intelligent recognition of the geological sweet spot consistent with mechanism cognition. The K-medoids clustering algorithm can improve the clustering effect by repeatedly replacing the reference point of the clustering set center with each data point, and the weighted distance function, the criterion function and the rating function that emphasize the key reservoir petrophysical parameter are constructed by the correlation analysis between the reservoir petrophysical parameters and the oil production profile data. The dual focus on the clustering center and the weighted functions can enhance robustness to the outliers, and can better capture potential geological mechanisms.

In some embodiments, clustering the first dataset according to the weighted clustering model in S101, in a specific implementation, may include:
selecting a preset quantity of clustering centers from the first dataset;
calculating weighted Euclidean distances from first sample points in the first dataset to the clustering centers according to the weighted Euclidean distance function, where the first sample points correspond to the reservoir petrophysical parameters at different horizontal well depths;
comparing the weighted Euclidean distances, and according to a comparison result, dividing the first sample points into a corresponding clustering set where the weighted Euclidean distances are less than a preset distance threshold value;
selecting a new clustering center from the clustering set according to the criterion function;
repeating the processes of calculating the weighted Euclidean distance, dividing the first sample points and selecting the new clustering center until a quantity of iterations reaches a preset iteration-quantity threshold or the newly selected clustering center remains unchanged, obtaining a clustered first clustering result.

Evaluating the geological sweet spots of clustered clusters to obtain the geological sweet spot evaluation result in S101, in a specific implementation, may include:
evaluating the clustered geological sweet spots in the first clustering result through the rating function to obtain the geological sweet spot evaluation result.

In some embodiments, evaluating the clustered geological sweet spots in the first clustering result through the rating function to obtain the geological sweet spot evaluation result, in a specific implementation, may include:
determining weighted geological sweet spot indexes of clusters in the first clustering result through the rating function;
comparing the weighted geological sweet spot indexes of the clusters, and ranking a comparison result of the weighted geological sweet spot indexes in a descending order, to obtain a ranking result of the weighted geological sweet spot indexes; and
rating corresponding geological sweet spots into different levels according to the ranking result of the weighted geological sweet spot indexes, so as to obtain the geological sweet spot evaluation result, where the geological sweet spot evaluation result includes a geological sweet spot category label.

Specifically, the steps of clustering the first dataset using the weighted K-medoids clustering algorithm (i.e., the above-mentioned weighted clustering model) are as follows:
1) Initialization: selecting a preset quantity (such as: K) of clustering centers from the first dataset randomly.
2) Weighted Euclidean distance allocation: calculating the weighted Euclidean distances from each first sample point to the K clustering centers according to the weighted Euclidean distance function, comparing the weighted Euclidean distances, and dividing them into a clustering set with a minimum weighted Euclidean distance (i.e., the weighted Euclidean distances are less than a preset distance threshold value, where the preset distance threshold value may be set according to actual requirements, and is not specifically limited in this specification) according to the comparison result.
3) Clustering center update: for each clustering set, selecting a new clustering set center by minimizing the criterion function WSSE.
4) Iteration: repeating the above steps 2)-3) until convergence (the newly selected clustering center remains unchanged) or the quantity of iterations reaches a preset iteration-quantity threshold, where the preset iteration-quantity threshold can be set according to practical requirements, and is not specifically limited in this specification.
5) Result: marking the first clustering result through the rating function, and dividing and rating the geological sweet spots into four categories (I, II, III, IV), corresponding successively to “first-level (excellent)”, “second-level (good)”, “third-level (normal)” and “fourth-level (poor)”, which correspond to the weighted geological sweet spot indexes (WGSSIs). Specifically, the weighted geological sweet spot indexes of the clusters in the first clustering result may be first determined through the rating function, then the weighted geological sweet spot indexes of the clusters can be compared and be ranked in a descending order according to the comparison result of the weighted geological sweet spot indexes, and then the corresponding geological sweet spots are rated as different grades according to the ranking result of the weighted geological sweet spot indexes, so as to obtain the geological sweet spot evaluation result. For example, the one ranked first indicate the highest weighted geological sweet spot index and the best geological sweet spot, and can be rated as first-level geological sweet spot, while the one ranked last indicate the lowest weighted geological sweet spot index and the worst geological sweet spot, and can be rated as fourth-level geological sweet spot, where I, II, III, IV can be used as geological sweet spot category labels.

The primary objective of the geological sweet spot recognition and evaluation is to delineate the reservoirs with good reservoir flow capacity and reservoir performance (such as high porosity, high oil saturation, high permeability and low clay content or low shale content). The well segments with similar reservoir characteristics are typically divided into the same category by using the clustering algorithm. However, unsupervised clustering techniques based on Euclidean typically assign the same weight to the reservoir petrophysical parameters, while ignoring their differential contribution to production dynamics. In order to address this limitation, in the present application, the mechanism-guided weighted clustering model is constructed according to the weights of the reservoir petrophysical parameters. Compared with the traditional techniques, the model focuses on the reservoir petrophysical parameters having a great influence on oil production, and reduces the influence of the reservoir petrophysical parameters having a small influence on oil production on the clustering result, thereby achieving the intelligent evaluation of the geological sweet spots.

S102: dividing a fracturing segment according to an engineering sweet spot evaluation result and a preset segment length constraint, where the engineering sweet spot evaluation result is determined according to a geomechanical parameter.

In some embodiments, the engineering sweet spot evaluation result being determined according to the geomechanical parameter in S102, in a specific implementation, may include:
determining a geomechanical strength according to the bottomhole mechanical specific energy and the minimum horizontal principal stress according to the following formula:

$${P}_{G e o} = M S {E}_{b} + {S}_{hmin}$$

where, P_{Geo} is the geomechanical strength, Mpa; MSE_{b} is the bottomhole mechanical specific energy, Mpa; and Sₕₘᵢₙ is the minimum horizontal principal stress, Mpa; and
evaluating an engineering sweet spot according to distribution of the geomechanical strength to obtain the engineering sweet spot evaluation result.

Specifically, the bottomhole mechanical specific energy (MSE_{b}) can be used as a characterization of the mechanical strength of the reservoir rock, enabling to effectively evaluate the fracture resistance of the rock under different pressure conditions; and the minimum horizontal principal stress Sₕₘᵢₙ plays a crucial role in the initiation and propagation of the fractures, affecting the deformation and destruction modes of the rock. By comprehensively considering these two parameters, the geomechanical properties of the reservoir can be evaluated more comprehensively, thereby providing scientific basis for engineering design and ultimately forming engineering sweet spot parameters, so as to provide an important basis for the well completion optimization design. The above-mentioned distribution of the geomechanical strength can intuitively show the engineering sweet spots of the horizontal well segment.

In some embodiments, each perforation cluster within a certain fracturing segment along the horizontal well has a corresponding fracture initiation pressure, and when the wellbore pressure exceeds this threshold, a corresponding fracture will initiate. A fracture initiation pressure condition may be expressed as:

$${P}_{w} > {T}_{str , eff , c} + {s}_{init , c} + {Ds}_{e , c} + {Ds}_{i , c}$$

where, P_{w} is a wellbore pressure (MPa); T_{str,eff,c} is an effective tensile strength (MPa); S_{init,c} is a stress shadow from previous stage (MPa); Ds_{e,c} is a stress shadow of other fractures at the same stage (MPa); and Ds_{i,c} is an initial magnitude of the minimum principle stress at a cluster (MPa).

In the fracturing initiation stage, when fractures have not expanded on a large scale, and the interference between the fractures can be ignored, the fracture initiation pressure condition can be further simplified as follows:

$${P}_{W} {}^{′} V \geq {P}_{G e o} = M S {E}_{b} + {S}_{hmin}$$

where P_{W}′ is the fracture initiation pressure, Mpa.

The engineering sweet spot may also be evaluated according to the the geomechanical strength distribution and the fracture initiation pressure, so as to obtain the engineering sweet spot evaluation result. For example, moderate geological strength and low fracture initiation pressure indicate high fracturing efficiency and controllable fractures, which can be prioritized for development, and the corresponding engineering sweet spot can be rated as first-level (excellent) engineering sweet spot. If the geological strength is too high/too low or the fracture initiation pressure is too high, it indicates that the fracturing risk is high and it is not recommended for development, and the corresponding engineering sweet spot can be evaluated as non-sweet spot, etc.

In some embodiments, the engineering sweet spot evaluation result in S102 may include the geomechanical strength along the horizontal well depth. Accordingly, dividing the fracturing segment according to the engineering sweet spot evaluation result and the preset segment length constraint in S102, in a specific implementation, may include:
constructing a second dataset according to the geomechanical strength along the horizontal well depth and a well depth, where second sample points in the second dataset correspond to different well depths and geomechanical strengths at different horizontal well depths;
constructing a geomechanical similarity item according to the geomechanical strengths of the second sample points and an average geomechanical strength of all second sample points;
constructing a segment length penalty term according to a well depth range of the fracturing segment and the preset segment length constraint;
constructing an objective function for dividing the fracturing segment according to the geomechanical similarity term and the segment length penalty term;
solving the objective function by using a dynamic programming algorithm to determine a segmentation point of the fracturing segment; and
dividing the fracturing segment according to the segmentation point to obtain a fracturing segment division result, where the fracturing segment division result includes a segment label.

Specifically, the geomechanical strength along the horizontal well depth and the well depth may be collected at first, so as to construct or form the second dataset

$${X}_{2} = {\{ {x}_{I} \}}_{I = 1}^{n} ,$$

where Xₗ corresponds to information on the well depth and the geomechanical strength for the I-th second sample point. The preset segment length constraint is determined, for example, such as setting a target segment length interval [a, b].

Then, according to a geomechanical strength X_{I} of the I-th second sample point in the well depth set S_{Q} within the Q-th fracturing segment and an average geomechanical strength m_{Q} of all second sample points within the Q-th fracturing segment, the geomechanical similarity term is constructed according to the following formula, that is, for the Q-th fracturing segment, a mean square error of sample X_{I} within it can be expressed as:

$${\sum }_{i ∈ {S}_{Q}} {( {X}_{I} - {m}_{Q} )}^{2}$$

where, the geomechanical similarity item can be used to measure the difference between the geomechanical strengths of the well segments in the same fracturing segment. The present application uses the sum of squared errors as the measurement index.

Then, according to the well depth range L_{Q} of the Q-th fracturing segment and the preset segment length constraint L_{target} (i.e., a target segment length interval, such as [a, b]), the segment length penalty term Penalty (L_{Q}) is constructed according to the following formula:

$$Penalty ( {L}_{Q} ) = {( {L}_{Q} - {L}_{target} )}^{2}$$

where, in order to ensure that the well depth range of each fracturing segment falls within the target segment length interval [a, b] (the interval can be determined according to the geological and engineering characteristics of different blocks), when there is a deviation between the actual segment length and the target segment length (for example, the median of the interval), the above segment length penalty can be introduced.

$${\sum }_{I ∈ {S}_{Q}} {( {X}_{I} - {m}_{Q} )}^{2}$$

Then, according to the geomechanical similarity term and the segment length penalty term Penalty (L_{Q}), the objective function for dividing the fracturing segment is constructed according to the following formula:

$$M = {\sum }_{J = 1}^{K} ( {\sum }_{I ∈ {S}_{Q}} {( {X}_{I} - {m}_{Q} )}^{2} + λ \cdot Penalty ( {L}_{Q} ) )$$

where, M is the objective function for dividing the fracturing segment; K is a total quantity of the fracturing segment (i.e., total quantity of clusters); S_{Q} is the well depth set within the Q-th fracturing segment; X_{I} is the geomechanical strength of the I-th second sample point; m_{Q} is the average geomechanical strength of all second sample points in the Q-th fracturing segment; λ is a weight factor governing the balance between the geomechanical similarity term and the segment length penalty term; L_{Q} is the well depth range of the Q-th fracturing segment.

Afterwards, the objective function M may be solved using a dynamic programming algorithm (DP algorithm) to determine a segmentation point of the fracturing segment. Then, the fracturing segment can be divided according to the segmentation point of the fracturing segment, so as to obtain a fracturing segment division result. The specific steps are shown as follows:
1) State definition: Defining D_{I} to represent an optimal objective function value of the first I second sample points (sample index is from 0 to I-1), while recording an optimal segmentation point seg[I], i.e., the index where the previous segment ends.
2) State transition: For each second sample point I, only considering a candidate starting point G that enables that the well depth difference=Depth[I-1]-Depth[G] falls within the target segment length interval [a, b], and calculating the objective function value M (G, I) within the interval [G, I). The state transition equation is as follows:

$$D ( I ) = {min}_{G ∈ K ( I )} \{ D ( G ) + M ( G , I ) \} .$$

3) Global optimal solution and backtracking: after recursively calculating D (n) by using dynamic programming, obtaining an optimal segmentation boundary index by backtracking, so as to determine the starting and ending positions of each fracturing segment, thereby achieving the intelligent division of the fracturing segment.

For example: it is supposed that there are well depth and geomechanical strength data as follows (forming the second dataset):

| | | Geomechanical |
|---|---|---|
| Sample index | Well depth | strength |
| 0 | 100 | 50 |
| 1 | 200 | 55 |
| 2 | 300 | 60 |
| 3 | 400 | 58 |
| 4 | 500 | 62 |
| 5 | 600 | 65 |
| 6 | 700 | 80 |
| 7 | 800 | 85 |
| 8 | 900 | 90 |
| 9 | 1000 | 95 |

and the target segment length interval [a, b]=[150,250], and the weight factor 2=1, then

Step 1, Initialization:

$$D ( 0 ) = 0$$

$$seg [ 0 ] = - 1$$

Step 2, State transition:
for each second sample point I from 1 to 9, calculating D_{I} as follows:
for I=1:
the candidate starting point G=0;
calculating M (0,1)=40000;

$$D ( 1 ) = D ( 0 ) + M ( 0 , 1 ) == 0 + 40000 = 40000 ;$$

$$seg [ 1 ] = 0$$

for I=2:
the candidate starting point G=0,1;
calculating M (0,2) and M (1,2);
choosing the smallest among them:

$$D ( 2 ) = min ( D ( 0 ) + M ( 0 , 2 ) , D ( 1 ) + M ( 1 , 2 ) ) ;$$

updating seg[2].

The above processes are repeated until I=9.

Step 3, backtracking: obtaining the optimal segmentation boundary index by backtracking, so as to determine the starting and ending positions (segmentation points) of each fracturing segment, so that the fracturing segment can be divided. The fracturing segment division result may include a segment label.

The above-mentioned dynamic programming algorithm is an effective method for solving the sequential optimization problem, and is particularly suitable for seeking a global optimal segmentation in a non-convex solution space. The dynamic programming algorithm divides the second dataset (including the well depth and the geomechanical strength along the horizontal well depth) into K segments, and finds the optimal segment division solution by minimizing the objective function. The objective thereof is to divide the wellbore into the fracturing segments, meeting a predetermined segment length requirement while ensuring that the geomechanical properties of the fracturing segments are as similar as possible. By using the dynamic programming algorithm, well segments with similar geomechanical strength can be divided into the same fracturing segment. This method integrates indicators of the well depth data and the geomechanical strength while maintaining the spatial continuity of reservoir intervals, takes the similarity of geomechanical strength within a segment as the objective function, and applies the segment length constraint penalty item according to construction requirements, achieving the intelligent division of the fracturing segment, and providing support for subsequent intelligent selection of the perforation cluster.

S103: solving a multi-objective function constructed according to the geological sweet spot evaluation result, the engineering sweet spot evaluation result and the preset cluster spacing constraint within the divided fracturing segment, and performing a well completion optimization design according to an objective solution result of the multi-objective function.

In some embodiments, before S103, in a specific implementation, the method can further include:
determining a geological sweet spot weight according to the geological sweet spot category label in the geological sweet spot evaluation result;
identifying the fracturing segment according to the segment label in the fracturing segment division result and imposing a constraint on a fracturing cluster within the fracturing segment, so that the fracturing cluster after the constraint is imposed is located within a preset segment depth range;
generating a candidate area according to the geomechanical strength along the horizontal well depth, and generating a candidate cluster from the candidate area;
taking a sum of geological sweet spot weights being greater than a preset weight threshold as a first objective, taking the geomechanical similarity item being less than a preset variance threshold as a second objective, and taking the preset cluster spacing constraint as a constraint condition;
constructing the multi-objective function based on the first objective, the second objective, and the constraint condition.

Specifically, the geological sweet spot weight W may be determined according to the geological sweet spot category label by using the following formula:

$${W}_{i} = 5 - {Class}_{i}$$

where, when i=1, it is the Label I (first-level class) and the maximum weight W1=4 is obtained, and when i=4, it is Label IV (fourth-level class) and the maximum weight W4=1 is obtained. The geological sweet spot weight will be used to construct the multi-objective function, thereby enabling multi-objective optimization for screening perforation clusters or fracturing clusters.

Then, the segment label can be used to identify the fracturing segments and apply a constraint to the fracturing clusters within each fracturing segment, so that all fracturing clusters within one fracturing segment must be within the preset segment depth range:

$${c}_{J}^{depth} ∈ [ {Stage}_{n , start} , {Stage}_{n , end} ]$$

where,

$${c}_{J}^{depth}$$

is a well depth coordinate of the J-th cluster within the n-th fracturing segment.

Then, the candidate area may be generated using the engineering sweet spot label (the geomechanical strength along the horizontal well depth). Unlike the traditional fixed threshold methods, the candidate area in the present application is dynamically defined: second sample points within the range of #10% of the average value m of the geomechanical strengths of the engineer sweet spots are determined as a high-quality engineering sweet spot area P_{Eng}, which is the input sample set for subsequent clustering:

$${P}_{Eng} ∈ [ 0.9 {m}_{n} , 1.1 {m}_{n} ]$$

Then, a DBSCAN clustering algorithm may be selected to further refine and select a reasonable initial cluster center in the candidate area (i.e., generating the candidate cluster from the candidate area), so as to create a better convergence condition for the subsequent multi-objective optimization. The DBSCAN can automatically identify the clusters according to data density, without defining a quantity of the clusters, and the DBSCAN can automatically identify a high-density area, ensuring that candidate cluster does not cross the well segment where the geomechanical properties change dramatically. Specifically, the steps of generating the candidate cluster by using the DBSCAN clustering algorithm are as follows.

### Step 1, Data Standardization

Within the candidate area, standardizing the two-dimensional data composed of Depth and Pgeo, allowing the DBSCAN to cluster on an unbiased scale.

The hyper-parameters that need to be set include a neighborhood radius eps and a minimum quantity of samples min_samples. The eps (neighborhood radius) may be used to define a density-reachable range of a point. The value can be adjusted according to the distribution characteristics of the data, usually ranging from 0.1 to 0.5, and is set as 0.3 herein. The min_samples (minimum quantity of samples) is used to set the minimum quantity of sample points included in one cluster to ensure that only sufficiently dense clusters are formed, and for the candidate area with fewer data points (<1000), the value is usually 3-5, and is set to 5 herein.

### Step 2, Clustering and Noise Filtering

The DBSCAN identifies the density reachability relationships of the data points according to the eps and the min_samples, assigns the interconnected high-density areas to the same cluster, and labels a low-density area as a noise point (label=−1). The noise points that do not belong to any dense area are filtered out.

### Step 3, Generation of Candidate Clustering Center

Generating a set of candidate clustering centers that represent the dense areas of high-quality engineering optimal point data and that comply with predefined engineering standards.

By optimizing the cluster center (generating the candidate cluster), a well constrained and physically meaningful initial solution space can be provided for the subsequent multi-objective optimization.

Then, the sum of the geological sweet spot weights being greater than a preset weight threshold can be taken as the first objective (i.e., maximizing the geological sweet spot score) to ensure that the selected cluster center corresponds to an area with favorable reservoir conditions. Specifically, the construction formula of the first objective f₁ is as follows:

$${f}_{1} = {\sum }_{i ∈ {S}_{J}} {W}_{i}$$

where, Wᵢ is the geological sweet spot weight of the i-th first sample point; and S_{J} is a first sample point set of the J-th cluster.

The geomechanical similarity term being less than a preset variance threshold may be used as the second objective (i.e., minimizing the variance of the geomechanical strength). This objective minimizes the differences in the geomechanical strength between the clustering sets, so as to ensure that the clustering sets exhibit similar mechanical properties. Specifically, the construction formula of the second objective f₂ is as follows:

$${f}_{2} = {\sum }_{I ∈ {S}_{Q}} {( {X}_{I} - {m}_{Q} )}^{2}$$

where, X_{I} is the geomechanical strength of the I-th second sample point; m_{Q} is the average geomechanical strength of all second sample points within the Q-th fracturing segment; S_{Q} is the well depth set within the Q-th fracturing segment.

The preset cluster spacing constraint may be used as the constraint condition. In order to prevent the selected clusters from being too close or too far apart from each other, adjacent clusters must maintain a spacing of 10m-30m, so as to reduce fracture interference and increase production efficiency. Specifically, when the depth difference is less than 10m or greater than 30m, a fixed penalty is imposed as follows:

$$10 m £ \vert {c}_{J} - {c}_{J + 1} \vert £ 30 m$$

where, c_{J} is the well depth of the J-th cluster.

Finally, the multi-objective function may be constructed based on the first objective, the second objective, and the constraint condition.

In some embodiments, solving the multi-objective function constructed according to the geological sweet spot evaluation result, the engineering sweet spot evaluation result and the preset cluster spacing constraint in S103, in a specific implementation, may include:
solving the multi-objective function through a multi-objective optimization algorithm, and determining an objective solution result of the multi-objective function from the candidate cluster.

Performing the well completion optimization design according to the objective solution result of the multi-objective function in S103, in a specific implementation, may include:
taking the objective solution result as an objective design scheme of the fracturing cluster in the fracturing segment, and performing the well completion optimization design according to the objective design scheme of the fracturing cluster.

Specifically, the multi-objective optimization algorithm (such as NSGA-II algorithm) may be used to solve the multi-objective function, and the optimal solution result (i.e., the objective solution result) of the multi-objective function is determined from the candidate cluster and is used as the objective design scheme of the fracturing cluster or the perforation cluster. The objective design scheme may include an optimal perforation cluster set, thereby providing key inputs for the intelligent well completion design, and ensuring optimal perforation locations and quantities.

The specific steps of the NSGA-II algorithm are shown as follows:
1) Population encoding and initialization: The candidate solution is encoded as a binary vector, where each gene corresponding to one candidate cluster (1 represents selection, 0 represents exclusion). The initial population size is set to 100 and initialized to a 50% biased random distribution.
2) Fitness assessment: For each individual, a geological sweet spot score and a geomechanical strength variance are calculated by assigning the data to the clusters according to the nearest depth. The spatial constraint is integrated into the objective function value.
3) Non-dominated ranking and crowding distance: all individuals are ranked using non-dominant ranking to generate Pareto fronts. Within each Pareto front, the crowding distance is calculated to maintain population diversity.
4) Selection, crossover, and mutation: Binary tournament selection with crowding comparison is used. Simulated binary crossover (SBX) and random exponential mutation are applied to generate offspring. The probability of the crossover is set to 0.7 and the probability of the mutation is set to 0.3.
5) Population update and iteration: Parent and offspring populations are combined, and the next generation is selected by means of the non-dominated ranking and the crowding distance, this process is iterated for 100 generations or until convergence.
6) Optimal solution extraction and post-processing: A Pareto optimal set is extracted from the final population, an optimal individual is selected from it, and a tiny random perturbation is imposed on the selected clusters, so as to obtain a final optimized cluster set.

Since the optimal selection of the perforation clusters needs to comprehensively consider the geological sweet spot, the engineering sweet spot, and the construction constraint, it is a typical nonlinear optimization problem, and it is necessary to construct a reasonable objective function and a constraint condition. In the present application, the threshold value method is firstly used to obtain ±10% of the average value of the geomechanical strength in the fracturing segment, and the candidate cluster set is obtained based on the threshold value and a collar position. Then, the DBSCAN density clustering algorithm is used to generate the candidate clustering center, and as a clustering method based on density, the DBSCAN does not need to predefine the quantity of clusters, and autonomously identifies high-density areas, thereby preventing the candidate clustering clusters from crossing the well segments with a significant change of the geological mechanical strength, and ultimately forming the candidate cluster set. In addition, the NSGA-II multi-objective optimization algorithm is used to construct the multi-objective function with the minimum difference in the geomechanical strength (from the perspective of the engineering sweet spot) of the preferred clusters in the segment, the maximum geological sweet spot score, and the penalty term for the construction cluster spacing requirement. The Pareto front search is used in the candidate cluster to generate an optimal set, i.e., an optimal perforation cluster set. Finally, a specific well completion scheme can be formulated according to the optimized perforation cluster design scheme, so as to ensure maximum fracturing and exploitation effects.

For example: it is supposed that a certain fracturing segment contains the following 10 sample points:

| | Well | Geological | | (MPa) |
|---|---|---|---|---|
| Sample | depth | sweet pot | Engineering sweet spot | Segment |
| No. | (m) | category(Gi) | geomechanical strength | label |
| 1 | 2000 | I | 35 | Segment 1 |
| 2 | 2005 | II | 32 | Segment 1 |
| 3 | 2010 | I | 30 | Segment 1 |
| 4 | 2015 | III | 28 | Segment 1 |
| 5 | 2020 | I | 36 | Segment 1 |
| 6 | 2025 | IV | 25 | Segment 1 |
| 7 | 2030 | II | 33 | Segment 1 |
| 8 | 2035 | I | 34 | Segment 1 |
| 9 | 2040 | I | 37 | Segment 1 |
| 10 | 2045 | III | 29 | Segment 1 |

Then, the data processing is first performed as follows.

### 1. Geological Sweet Spot Weight Allocation:

$${Class}_{i} = {Class}_{1} = I ( Weight 4 ) , II ( Weight 3 ) , III ( Weight 2 ) , IV ( Weight 1 ) .$$

For example: the weight W₁ of sample 1=4, and the weight W₄ of sample 4=1

### 2. Inter-segment Constraint

All clusters must be located within the depth range of Segment 1 (2000m-2050m).

### 3. Generation of Candidate Area of Engineering Sweet Spots

Calculating an average value of the geomechanical strengths of the engineering sweet spots, m=31.9 MPa, with a dynamic range of 31.9±3.19 MPa (i.e., 28.7-35.1 MPa);
screening the samples that meet the condition: Sample 1 (35), Sample 2 (32), Sample 3 (30), Sample 5 (36), Sample 7 (33), Sample 8 (34), and Sample 9 (37).

The samples of the candidate area are: Sample 1, Sample 2, Sample 3, Sample 5, Sample 7, Sample 8, and Sample 9.

Then, initialization of the candidate cluster based on the BSCAN is performed as follows.

### 1. Data Standardization

Standardizing the well depth (Depth) and the geological sweet spot weight (Pgeo) to eliminate the influence of dimensionality.

### 2. Parameter Setting of DBSCAN

eps=0.3 (neighborhood radius), min_samples=5 (minimum quantity of samples).

### 3. Clustering Result

Cluster 1: Sample 1 (2000m), Sample 2 (2005m), Sample 3 (2010m), Sample 5 (2020m), Sample 7 (2030m), and Sample 8 (2035m);
Cluster 2: Sample 9 (2040m);
Noise Point: Sample 5 (2020m) is filtered due to insufficient density (assumed).

### 4. Extraction of Candidate Cluster Centers

Center of cluster 1: the well depth is 2016.7 m, and the average value of the geological sweet spot weights is 3.5;
Center of cluster 2: the well depth is 2040m, and the geological sweet spot weight is 4.

Then, the perforation cluster optimization based on NSGA-II is performed as follows.

### 1. Optimization Objective and Constraint

Objective 1: minimizing the variance of the geomechanical strength between the clusters;
Objective 2: maximizing the sum of the geological sweet spot scores;
Constraint: the cluster spacing needs to be in the range of 10-30m.

### 2. NSGA-II Parameters Setting

Population size: 100, quantity of iterations: 100;
Crossover probability: 0.7, mutation probability: 0.3.

### 3. Example Optimization Process

### 1) Population Encoding:

The candidate clusters are Cluster 1 and Cluster 2, coded as binary vectors (e.g., [1, 0] represents the selection of Cluster 1)

### 2) Fitness Calculation:

Scenario 1: selecting Cluster 1 and Cluster 2 (encoding [1, 1]).

Geomechanical strength variance: Cluster 1 (30.8-36 MPa), Cluster 2 (37 MPa), with a relatively large variance.

Geographical sweet spot score: sum of weights in Cluster 1=4±3±4±4=15, weight of Cluster 2=4, total score=19.

Constraint penalty: the cluster spacing=2040-2016.7=23.3 m (satisfied, no penalty).

Scenario 2: selecting only Cluster 1 (encoding [1, 0]).

Geomechanical strength variance: internal variance of Cluster 1=2.8.

Geological sweet spot score=15.

There is no cluster spacing constraint (single cluster only).

### 3) Pareto Front Solution:

Solution A (selecting Cluster 1 and Cluster 2): total score 19, high variance.

Solution B (selecting only Cluster 1): total score 15, low variance.

### 4) Optimal Solution Selection:

If the total score and variance are preferentially balanced, selecting Solution A and apply a random perturbation (e.g., adjusting the center of Cluster 1 to 2015m).

Finally, through the collaborative optimization of the DBSCAN and the NSGA-II, Cluster 1 (2000-2035m) is finally selected as the optimal perforation cluster, with a high geological sweet spot score (15) and a low geomechanical strength variance (2.8), and satisfying the depth constraint within the segment. If multiple clusters are required, the spacing between the candidate clusters needs to be adjusted or the constraints needs to be relaxed.

The various embodiments in this specification are described in a progressive manner, the same or similar parts between the embodiments can be referred to each other, and each embodiment focuses on differences from other embodiments. The specific details can refer to the relevant description of relevant processing embodiments mentioned above, and will not be repeated here.

This method has been described in the above. However, it should be noted that this specific embodiment is only for better illustration of the present application and for the description of one specific embodiment in the specification. Other embodiments are within the scope of the appended claims. In some cases, the actions or steps described in the claims may be performed in a different order than in the embodiments and still achieve the desirable results. In addition, the process depicted in the accompanying drawings does not necessarily require a specific or continuous order shown to achieve desirable results. In certain embodiments, multitasking and parallel processing are also feasible or may be advantageous.

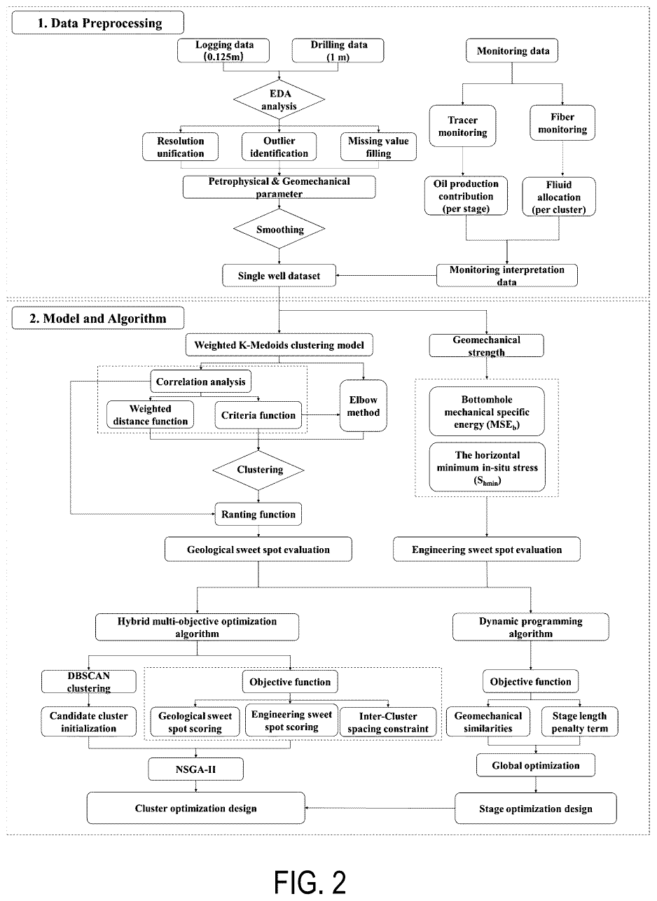

In a specific implementation scenario, as shown in FIG. 2, a process of the intelligent well completion optimization design method based on multi-objective optimization can be shown in the below.

### I. Data Processing

The easily accessible and valuable data in drilling, well completion and production processes are collected, such as logging data (0.125m), drilling data (1m) and post-fracturing monitoring data. The exploratory data analysis (EDA) is used to understand the structure, distribution and quality of the logging data and the drilling data through statistical methods and visualization. Then the unified measurement, outlier processing, missing value imputation and other pre-processing are performed on the logging data and the drilling data, and the reservoir petrophysical parameters and the geomechanical parameter are calculated according to the pre-processed drilling data and/or logging data. Then the smoothing and denoising processing is performed on the reservoir petrophysical parameters and the geomechanical parameter, so as to form a single well dataset. The post-fracturing monitoring data can include tracer monitoring and optical fiber monitoring, where the tracer monitoring can obtain oil production contribution rate/segment (i.e., oil production profile data), and the optical fiber monitoring can obtain fluid distribution amount/cluster, which can be used for monitoring and interpretation.

### II. Model and Algorithm

The correlation analysis is first performed on the reservoir petrophysical parameters and the oil production profile data to calculate the Spearman correlation coefficient, and further to determine the weights of the reservoir petrophysical parameters. Then, the weighted Euclidean distance function, the criterion function, and the rating function are constructed according to the weights of the reservoir petrophysical parameters. Then, the mechanism-guided weighted K-medoids clustering model or algorithm is constructed based on the weighted Euclidean distance function, the criterion function, and the rating function. The preset total quantity K of clusters is determined based on the “elbow rule”. The weighted Euclidean distance function and the criterion function can be used to perform clustering, and the rating function is used to evaluate the clustered geological sweet spots in the first clustering result, so as to obtain the geological sweet spot evaluation result.

The geomechanical strength can be determined according to the bottomhole mechanical specific energy MSE_{b} and the minimum horizontal principal stress Sₕₘᵢₙ, and then the engineering sweet spot evaluation is performed. The objective function for dividing the fracturing segment can be constructed according to the geomechanical similarity term (with similar geomechanical strength) and the segment length penalty term (the fracturing segment length constraint penalty term). The dynamic programming algorithm (DP) is used to solve the objective function for dividing the fracturing segment, to achieve global optimization, and the starting and ending positions (segmentation points) of each fracturing segment are determined, so as to divide the fracturing segment and achieve the fracturing segment optimization.

After the fracturing segment is divided, the threshold method can be used to obtain 10% of the average value of the geomechanical strength within the fracturing segment. The candidate cluster set is obtained based on the threshold and the collar position, then the candidate cluster center is generated by using the DBSCAN density cluster algorithm, ultimately forming the initial candidate cluster or the candidate cluster. The multi-objective function is constructed according to the geological sweet spot evaluation result, the engineering sweet spot evaluation result and the preset cluster spacing constraint (cluster spacing constraint). By means of the NSGA-II multi-objective optimization algorithm, on the premise of satisfying physical constraints, the optimal perforation cluster set is further selected from the candidate cluster, so as to achieve a perforation cluster optimization design, thereby providing the key inputs for the intelligent well completion design, and ensuring optimal perforation positions and quantities.

By quantifying the relationship between the reservoir petrophysical parameters and the oil production profile data through the correlation analysis, the mechanism-guided weighted Euclidean clustering is constructed, and the mechanism-guided weighted clustering model is established, so as to conduct the sweet spot evaluation that is more in line with geological principles.

By constructing the objective function for dividing the fracturing segment according to the geomechanical similarity item and the segment length penalty item, it not only takes the geomechanical strength into account, but also integrates constraints on the fracturing segment length and spatial continuity, so that the DP algorithm can automatically generate a reasonable fracturing segment design without manual intervention.

On the basis of the threshold method and DBSCAN density clustering to generate the candidate clusters, the multi-objective optimization algorithm is adopted to incorporate the geological sweet spot point, the engineering sweet spot point and the perforation cluster spacing into its objective function and penalty term. This not only ensures that the candidate clusters have similar geological mechanical conditions, but also can improve the quality of the geological sweet spot points to the maximum extent and reduce inter-seam interference and collar damage, thereby improving the transformation effectiveness.

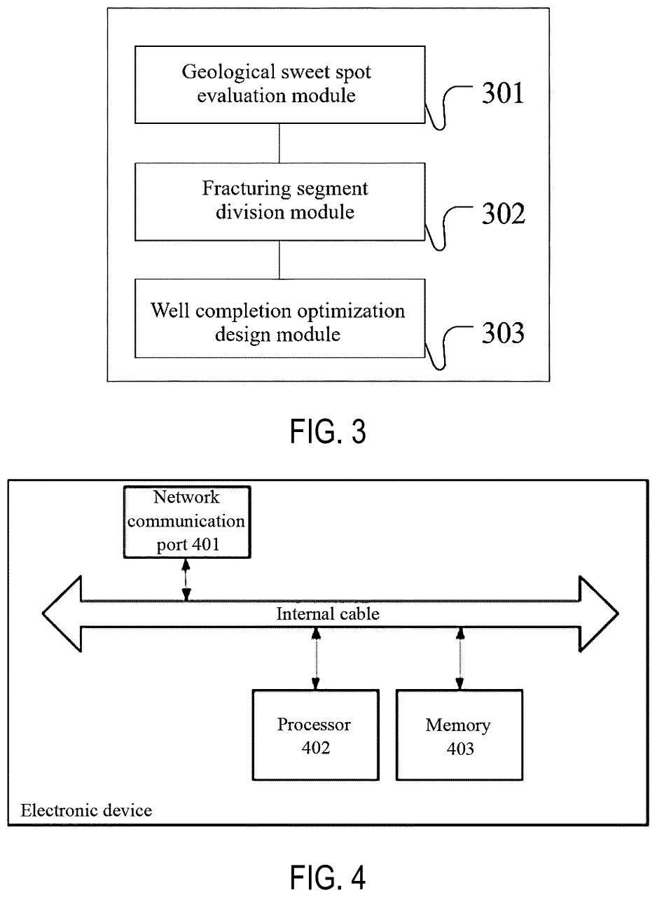

Although this specification provides method operation steps or device structures as shown in the following embodiments or FIG. 3, more operational steps or module units, or fewer ones after partial combination, may be included in the described method or apparatus on the basis of routine or non-creative efforts. In steps or module structures where there is no necessary causal relationship in logic, the execution order of the steps or the module structure of the apparatus is not limited to the execution order or the module structure shown in the embodiments or accompanying drawings of this specification. When the method or the module structure is applied to a practical apparatus, a server, or a terminal product, it can be executed sequentially or in parallel according to the method or the module structure shown in the embodiments or accompanying drawings (such as a parallel processor or a multi-thread processing environment, or even an implementation environment of distributed processing or server cluster). Based on the above-mentioned intelligent well completion optimization design method based on multi-objective optimization, an embodiment of this specification also provides an embodiment of an intelligent well completion optimization design apparatus based on multi-objective optimization. As shown in FIG. 3, the apparatus may specifically include the following modules:
a geological sweet spot evaluation module 301, configured to cluster a first dataset according to a weighted clustering model, and evaluate the geological sweet spots of clustered clusters to obtain a geological sweet spot evaluation result, where the first dataset includes reservoir petrophysical parameters along a horizontal well depth, and the weighted clustering model is constructed according to weights of the reservoir petrophysical parameters;
a fracturing segment division module 302, configured to divide a fracturing segment according to an engineering sweet spot evaluation result and a preset segment length constraint, where the engineering sweet spot evaluation result is determined according to a geomechanical parameter; and
a well completion optimization design module 303, configured to solve a multi-objective function constructed according to the geological sweet spot evaluation result, the engineering sweet spot evaluation result and a preset cluster spacing constraint within the divided fracturing segment, and perform a well completion optimization design according to an objective solution result of the multi-objective function.

In some embodiments, the above-mentioned geological sweet spot evaluation module 301 can be specifically configured to: calculate correlation coefficients between the reservoir petrophysical parameters and oil production profile data; determine a sum of absolute values of the correlation coefficients between the reservoir petrophysical parameters and the oil production profile data; and determine the weights of the reservoir petrophysical parameters according to the correlation coefficients between the reservoir petrophysical parameters and the oil production profile data as well as the sum of absolute values of the correlation coefficients.

In some embodiments, the above-mentioned geological sweet spot evaluation module 301 may be specifically configured to: construct a weighted Euclidean distance function, a criterion function and a rating function according to the weights of the reservoir petrophysical parameters; and construct the weighted clustering model according to the weighted Euclidean distance function, the criterion function and the rating function.

In some embodiments, the above-mentioned geological sweet spot evaluation module 301 may be further specifically configured to: select a preset quantity of clustering centers from the first dataset; calculate weighted Euclidean distances from first sample points in the first dataset to the clustering centers according to the weighted Euclidean distance function, where the first sample points correspond to the reservoir petrophysical parameters at different horizontal well depths; compare the weighted Euclidean distances, and divide the first sample points into a corresponding clustering set where the weighted Euclidean distances are less than a preset distance threshold value according to a comparison result; select a new clustering center from the clustering set according to the criterion function; repeat the processes of calculating the weighted Euclidean distances, dividing the first sample points and selecting the new clustering center until a quantity of iterations reaches a preset iteration-quantity threshold or newly selected clustering center remains unchanged, to obtain a clustered first clustering result; and evaluate the clustered geological sweet spot in the first clustering result through the rating function to obtain the geological sweet spot evaluation result.

In some embodiments, the above-mentioned geological sweet spot evaluation module 301 may be further specifically configured to: determine weighted geological sweet spot indexes of clusters in the first clustering result through the rating function; compare the weighted geological sweet spot indexes of the clusters, and rank a comparison result of the weighted geological sweet spot indexes in a descending order, to obtain a ranking result of the weighted geological sweet spot indexes; and rate corresponding geological sweet spots into different levels according to the ranking result of the weighted geological sweet spot indexes, so as to obtain the geological sweet spot evaluation result, where the geological sweet spot evaluation result includes a geological sweet spot category label.

In some embodiments, the engineering sweet spot evaluation results include a geomechanical strength along the horizontal well depth; and accordingly, the above-mentioned fracturing segment division module 302 may specifically configured to: construct a second dataset according to the geomechanical strength along the horizontal well depth and a well depth, where second sample points in the second dataset correspond to different well depths and geomechanical strengths at different horizontal well depths; construct a geomechanical similarity item according to the geomechanical strengths of the second sample points and an average geomechanical strength of all second sample points; construct a segment length penalty term according to a well depth range of the fracturing segment and the preset segment length constraint; construct an objective function dividing the fracturing segment according to the geomechanical similarity term and the segment length penalty term; solve the objective function by using a dynamic programming algorithm to determine a segmentation point of the fracturing segment; and divide the fracturing segment according to the segmentation point to obtain a fracturing segment division result, where the fracturing segment division result includes a segment label.

In some embodiments, the well completion optimization design module 303 may specifically configured to: determine a geological sweet spot weight according to the geological sweet spot category label in the geological sweet spot evaluation result; identify the fracturing segment according to the segment label in the fracturing segment division result and impose a constraint on a fracturing cluster within the fracturing segment, so that the fracturing cluster after the constraint is imposed is located within a preset segment depth range; generate a candidate area according to the geomechanical strength along the horizontal well depth, and generate a candidate cluster from the candidate area; take a sum of geological sweet spot weights being greater than a preset weight threshold as a first objective, take the geomechanical similarity item being less than a preset variance threshold as a second objective, and take the preset cluster spacing constraint as a constraint condition; and construct the multi-objective function based on the first objective, the second objective, and the constraint condition.

In some embodiments, the well completion optimization design module 303 may specifically configured to: solve the multi-objective function through a multi-objective optimization algorithm and determine an objective solution result of the multi-objective function from the candidate cluster; take the objective solution result as an objective design scheme of the fracturing cluster in the fracturing segment, and perform the well completion optimization design according to the objective design scheme of the fracturing cluster.

As can be seen from the above, based on the intelligent well completion optimization design apparatus based on multi-objective optimization provided in the embodiments of this specification, the automation and intelligent design of positions of the fracturing segment and the perforation cluster can be achieved, thereby providing a new technical approach for optimizing the well completion design of unconventional oil and gas reservoirs, and having important engineering applicability.

An embodiment of this specification also provides an electronic device based on the above-mentioned intelligent well completion optimization design method based on multi-objective optimization, the electronic device includes a processor and a memory for storing executable programs/instructions of the processor. The processor, in a specific implementation, can execute the following steps according to the programs/instructions: clustering a first dataset according to a weighted clustering model, and evaluating geological sweet spots of clustered clusters to obtain a geological sweet spot evaluation result, where the first dataset includes reservoir petrophysical parameters along a horizontal well depth, and the weighted clustering model is constructed according to weights of the reservoir petrophysical parameters; dividing a fracturing segment according to an engineering sweet spot evaluation result and a preset segment length constraint, where the engineering sweet spot evaluation result is determined according to a geomechanical parameter; and solving a multi-objective function constructed according to the geological sweet spot evaluation result, the engineering sweet spot evaluation result and a preset cluster spacing constraint within the divided fracturing segment, and performing a well completion optimization design according to an objective solution result of the multi-objective function.

In order to more accurately complete the above-mentioned instructions, as shown in FIG. 4, an embodiments of this specification also provides another specific electronic device, where the electronic device includes a network communication port 401, a processor 402 and a memory 403, and the above structures are connected through an internal cable so that these structures can perform specific data interaction.

The processor 402 may be specifically configured to: cluster a first dataset according to a weighted clustering model, and evaluate geological sweet spots of clustered clusters to obtain a geological sweet spot evaluation result, where the first dataset includes reservoir petrophysical parameters along a horizontal well depth, and the weighted clustering model is constructed according to weights of the reservoir petrophysical parameters; divide a fracturing segment according to an engineering sweet spot evaluation result and a preset segment length constraint, where the engineering sweet spot evaluation result is determined according to a geomechanical parameter; and solve a multi-objective function constructed according to the geological sweet spot evaluation result, the engineering sweet spot evaluation result and a preset cluster spacing constraint within the divided fracturing segment, and perform well completion optimization design according to an objective solution result of the multi-objective function.

The memory 403 may be specifically configured to store corresponding instruction programs.

In this embodiment, the network communication port 401 may be a virtual port bound to different communication protocols so as to send or receive different data. For example, the network communication port may be a port responsible for performing web data communication, a port responsible for performing FTP data communication, or a port responsible for performing mail data communication. In addition, the network communication port may also be a physical communication interface or communication chip. For example, it can be a wireless mobile network communication chip, such as GSM, CDMA, etc.; it can also be a Wifi chip; and it can also be a Bluetooth chip.

In this embodiment, the processor 402 may be implemented in any suitable manner.

For example, the processor may be in the form of microprocessor or processor and computer-readable medium that stores computer-readable program codes (such as software or firmware) executable by the (micro) processor, logic gates, switches, an application specific integrated circuit (Application Specific Integrated Circuit, ASIC), a programmable logic controller, and an embedded microcontroller, etc. This specification is not limited thereto.

In this embodiment, the memory 403 may include a plurality of layers, and in a digital system, any element that can store binary data can serve as a memory. In an integrated circuit, a circuit without a physical form and having a storage function is also called a memory, such as RAM and FIFO. In a system, a storage device in a physical form is also called a memory, such as a memory bank or a TF card.

An embodiment of this specification also provides a computer storage medium based on the above-mentioned intelligent well completion optimization design method based on multi-objective optimization. The computer storage medium stores a computer program/instruction which, when being executed, is configured to: cluster a first dataset according to a weighted clustering model, and evaluate geological sweet spots of clustered clusters to obtain a geological sweet spot evaluation result, where the first dataset includes reservoir petrophysical parameters along a horizontal well depth, and the weighted clustering model is constructed according to weights of the reservoir petrophysical parameters; divide a fracturing segment according to an engineering sweet spot evaluation result and a preset segment length constraint, where the engineering sweet spot evaluation result is determined according to a geomechanical parameter; and solve a multi-objective function constructed according to the geological sweet spot evaluation result, the engineering sweet spot evaluation result and a preset cluster spacing constraint within the divided fracturing segment, and perform a well completion optimization design according to an objective solution result of the multi-objective function.

In this embodiment, the above storage medium includes, but is not limited to, a random access memory (Random Access Memory, RAM), a read-only memory (Read-Only Memory, ROM), a cache (Cache), a hard disk drive (Hard Disk Drive, HDD) or a memory card (Memory Card). The memory may be configured to store computer program instructions. The network communication unit may be an interface set according to standards specified in the communication protocol and configured to perform network connection communication.

In this embodiment, the functions and effects achieved by the program instructions stored in the computer storage medium may be explained in comparison with other embodiments, and not be repeated here again.

Although this specification provides method operational steps as described in the embodiments or flowcharts, more or fewer operational steps may be included on basis of routine or non-creative means. The sequence of steps listed in the embodiments is only one of numerous execution sequences of steps, and does not represent a unique execution sequence. In practice, the execution of the apparatus or the client product may be performed sequentially or in parallel according to the methods shown in the embodiments or the accompanying drawings (for example, a parallel processor or a multi-thread processing environment, or even a distributed data processing environment). The terms “include”, “contain”, or any other variant thereof are intended to cover a non-exclusive inclusion, so that a process, a method, a product, or a device that includes a series of elements not only includes these elements, but also includes other elements that are not expressly listed, or further includes elements inherent to the process, the method, the product, or the device. Without further limitations, it is not excluded that additional identical or equivalent elements exist in the process, method, product, or device that includes these elements. The terms first, second, and other words are used to represent names and do not indicate any specific order.

Those skilled in the art also know that, in addition to implementing the controller in the form of pure computer-readable program code, the controller may implement the same function in the form of logic gates, switches, application-specific integrated circuits, programmable logic controllers and embedded microcontrollers by performing logic programming on method steps. Therefore, such a controller may be regarded as a hardware component, and devices included therein for implementing various functions may also be regarded as structures within the hardware component. Or even, the devices for implementing the various functions may be regarded as both software modules for implementing the method and structures within the hardware component.

This specification may be practiced in the general context of computer-executable instructions executed by a computer, such as program modules. Generally, the program modules include routines, programs, objects, components, data structures, classes, etc., that perform particular tasks or implement particular abstract data types. This specification may also be practiced in distributed computing environments where tasks are performed by remote processing devices connected through a communication network. In the distributed computing environments, the program modules may be located on both local and remote computer storage media including storage devices.

It can be seen from the description of the above-mentioned embodiments that those skilled in the art may clearly understand that this specification may be implemented through software and necessary universal hardware platforms. Based on this understanding, the technical solution of this specification can be substantially embodied in the form of a software product, the software product may be stored in a storage medium, such as a ROM/RAM, a magnetic disk, or an optical disc, and includes several instructions to enable a computer device (which may be a personal computer, a mobile terminal, a server, a network device, etc.) to implement the methods described in embodiments or parts of the embodiments of this manual.

The embodiments in this specification are described in a progressive manner, the same or similar parts between the embodiments may refer to each other, and each embodiment focuses on the differences from the other embodiments. This specification may be used in numerous general-purpose or special-purpose computer system environments or configurations, such as: personal computers, server computers, handheld devices or portable devices, tablet devices, multiprocessor systems, microprocessor-based systems, set-top boxes, programmable electronic devices, network PCs, minicomputers, mainframe computers, distributed computing environments that include any of the above systems or devices, and so on.

Although this specification has been described through embodiments, those skilled in the art that should know that there are many variations of this specification without departing from the spirit of this specification, and it is intended that the appended claims cover such variations without departing from the spirit of this specification.

What is claimed is:

1. An intelligent well completion optimization design method based on multi-objective optimization, comprising:
clustering a first dataset according to a weighted clustering model, and evaluating geological sweet spots of clustered clusters to obtain a geological sweet spot evaluation result, wherein the first dataset comprises reservoir petrophysical parameters along a horizontal well depth, and the weighted clustering model is constructed according to weights of the reservoir petrophysical parameters;
dividing a fracturing segment according to an engineering sweet spot evaluation result and a preset segment length constraint, wherein the engineering sweet spot evaluation result is determined according to a geomechanical parameter; and
solving a multi-objective function constructed according to the geological sweet spot evaluation result, the engineering sweet spot evaluation result and a preset cluster spacing constraint within the divided fracturing segment, and performing a well completion optimization design according to an objective solution result of the multi-objective function.

2. The method according to claim 1, wherein the method further comprises:
calculating correlation coefficients between the reservoir petrophysical parameters and oil production profile data;
determining a sum of absolute values of the correlation coefficients between the reservoir petrophysical parameters and the oil production profile data; and
determining the weights of the reservoir petrophysical parameters according to the correlation coefficients between the reservoir petrophysical parameters and the oil production profile data as well as the sum of absolute values of the correlation coefficients.

3. The method according to claim 1, wherein the weighted clustering model being constructed according to the weights of the reservoir petrophysical parameters, comprises:
constructing a weighted Euclidean distance function, a criterion function and a rating function according to the weights of the reservoir petrophysical parameters; and
constructing the weighted clustering model according to the weighted Euclidean distance function, the criterion function and the rating function.

4. The method according to claim 3, wherein clustering the first dataset according to the weighted clustering model comprises:
selecting a preset quantity of clustering centers from the first dataset;
calculating weighted Euclidean distances from first sample points in the first dataset to the clustering centers according to the weighted Euclidean distance function, wherein the first sample points correspond to the reservoir petrophysical parameters at different horizontal well depths;
comparing the weighted Euclidean distances, and according to a comparison result, dividing the first sample points into a corresponding clustering set where the weighted Euclidean distances are less than a preset distance threshold value;
selecting a new clustering center from the clustering set according to the criterion function;
repeating the processes of calculating the weighted Euclidean distances, dividing the first sample points and selecting the new clustering center until a quantity of iterations reaches a preset iteration-quantity threshold or a newly selected clustering center remains unchanged, to obtain a clustered first clustering result, and
wherein evaluating the geological sweet spots of the clustered clusters to obtain the geological sweet spot evaluation result, comprises:
evaluating the clustered geological sweet spots in the first clustering result through the rating function to obtain the geological sweet spot evaluation result.

5. The method according to claim 4, wherein evaluating the clustered geological sweet spots in the first clustering result through the rating function to obtain the geological sweet spot evaluation result comprises:
determining weighted geological sweet spot indexes of the clusters in the first clustering result through the rating function;
comparing the weighted geological sweet spot indexes of the clusters, and ranking a comparison result of the weighted geological sweet spot indexes in a descending order, to obtain a ranking result of the weighted geological sweet spot indexes; and
rating corresponding geological sweet spots into different levels according to the ranking result of the weighted geological sweet spot indexes, so as to obtain the geological sweet spot evaluation result, wherein the geological sweet spot evaluation result comprises a geological sweet spot category label.

6. The method according to claim 1, wherein the engineering sweet spot evaluation result comprises a geomechanical strength along the horizontal well depth; and accordingly, dividing the fracturing segment according to the engineering sweet spot evaluation result and the preset segment length constraint comprises:
constructing a second dataset according to the geomechanical strength along the horizontal well depth and a well depth, wherein second sample points in the second dataset correspond to different well depths and geomechanical strengths at different horizontal well depths;
constructing a geomechanical similarity item according to the geomechanical strengths of the second sample points and an average geomechanical strength of all second sample points;
constructing a segment length penalty term according to a well depth range of the fracturing segment and the preset segment length constraint;
constructing an objective function for dividing the fracturing segment according to the geomechanical similarity term and the segment length penalty term;
solving the objective function by using a dynamic programming algorithm to determine a segmentation point of the fracturing segment; and
dividing the fracturing segment according to the segmentation point to obtain a fracturing segment division result, wherein the fracturing segment division result comprises a segment label.

7. The method according to claim 1, wherein the method further comprises:
determining a geological sweet spot weight according to the geological sweet spot category label in the geological sweet spot evaluation result;
identifying the fracturing segment according to the segment label in the fracturing segment division result and imposing a constraint on a fracturing cluster within the fracturing segment, so that the fracturing cluster after the constraint is imposed is located within a preset segment depth range;
generating a candidate area according to the geomechanical strength along the horizontal well depth, and generating a candidate cluster from the candidate area;
taking a sum of geological sweet spot weights being greater than a preset weight threshold as a first objective, taking the geomechanical similarity item being less than a preset variance threshold as a second objective, and taking the preset cluster spacing constraint as a constraint condition; and
constructing the multi-objective function based on the first objective, the second objective, and the constraint condition.

8. The method according to claim 7, wherein solving the multi-objective function constructed according to the geological sweet spot evaluation result, the engineering sweet spot evaluation result and the preset cluster spacing constraint comprises:
solving the multi-objective function through a multi-objective optimization algorithm, and determining an objective solution result of the multi-objective function from the candidate cluster, and
wherein performing the well completion optimization design according to the objective solution result of the multi-objective function comprises:
taking the objective solution result as an objective design scheme of the fracturing cluster in the fracturing segment, and performing the well completion optimization design according to the objective design scheme of the fracturing cluster.

9. An intelligent well completion optimization design apparatus based on multi-objective optimization, comprising:
a geological sweet spot evaluation module, configured to cluster a first dataset according to a weighted clustering model, and evaluate geological sweet spots of clustered clusters to obtain a geological sweet spot evaluation result, wherein the first dataset comprises reservoir petrophysical parameters along a horizontal well depth, and the weighted clustering model is constructed according to weights of the reservoir petrophysical parameters;
a fracturing segment division module, configured to divide a fracturing segment according to an engineering sweet spot evaluation result and a preset segment length constraint, wherein the engineering sweet spot evaluation result is determined according to a geomechanical parameter; and
a well completion optimization design module, configured to solve a multi-objective function constructed according to the geological sweet spot evaluation result, the engineering sweet spot evaluation result and a preset cluster spacing constraint within the divided fracturing segment, and perform a well completion optimization design according to an objective solution result of the multi-objective function.

10. The apparatus according to claim 9, further comprising: a memory and a processor, wherein the memory and the processor are in communication connection with each other, the memory stores computer program instructions, and
when the computer program instructions stored in the memory are executed, the processor is configured to drive geological sweet spot evaluation module, the fracturing segment division module and the well completion optimization design module,
the processor is further configured to:
calculate correlation coefficients between the reservoir petrophysical parameters and oil production profile data;
determine a sum of absolute values of the correlation coefficients between the reservoir petrophysical parameters and the oil production profile data; and
determine the weights of the reservoir petrophysical parameters according to the correlation coefficients between the reservoir petrophysical parameters and the oil production profile data as well as the sum of absolute values of the correlation coefficients.

11. The apparatus according to claim 10, wherein when the weighted clustering model being constructed according to the weights of the reservoir petrophysical parameters, the processor is specifically configured to:
construct a weighted Euclidean distance function, a criterion function and a rating function according to the weights of the reservoir petrophysical parameters; and
construct the weighted clustering model according to the weighted Euclidean distance function, the criterion function and the rating function.

12. The apparatus according to claim 11, wherein when clustering the first dataset according to the weighted clustering model, the processor is specifically configured to:
select a preset quantity of clustering centers from the first dataset;
calculate weighted Euclidean distances from first sample points in the first dataset to the clustering centers according to the weighted Euclidean distance function, wherein the first sample points correspond to the reservoir petrophysical parameters at different horizontal well depths;
compare the weighted Euclidean distances, and according to a comparison result, divide the first sample points into a corresponding clustering set where the weighted Euclidean distances are less than a preset distance threshold value;
select a new clustering center from the clustering set according to the criterion function;
repeat the processes of calculating the weighted Euclidean distances, dividing the first sample points and selecting the new clustering center until a quantity of iterations reaches a preset iteration-quantity threshold or a newly selected clustering center remains unchanged, to obtain a clustered first clustering result, and
wherein when evaluating the geological sweet spots of the clustered clusters to obtain the geological sweet spot evaluation result, the processor is specifically configured to:
evaluate the clustered geological sweet spots in the first clustering result through the rating function to obtain the geological sweet spot evaluation result.

13. The apparatus according to claim 12, wherein when evaluating the clustered geological sweet spots in the first clustering result through the rating function to obtain the geological sweet spot evaluation result, the processor is specifically configured to:
determine weighted geological sweet spot indexes of the clusters in the first clustering result through the rating function;
compare the weighted geological sweet spot indexes of the clusters, and rank a comparison result of the weighted geological sweet spot indexes in a descending order, to obtain a ranking result of the weighted geological sweet spot indexes; and
rate corresponding geological sweet spots into different levels according to the ranking result of the weighted geological sweet spot indexes, so as to obtain the geological sweet spot evaluation result, wherein the geological sweet spot evaluation result comprises a geological sweet spot category label.

14. The apparatus according to claim 10, wherein the engineering sweet spot evaluation result comprises a geomechanical strength along the horizontal well depth; and accordingly, when dividing the fracturing segment according to the engineering sweet spot evaluation result and the preset segment length constraint, the processor is specifically configured to:
construct a second dataset according to the geomechanical strength along the horizontal well depth and a well depth, wherein second sample points in the second dataset correspond to different well depths and geomechanical strengths at different horizontal well depths;
construct a geomechanical similarity item according to the geomechanical strengths of the second sample points and an average geomechanical strength of all second sample points;
construct a segment length penalty term according to a well depth range of the fracturing segment and the preset segment length constraint;
construct an objective function for dividing the fracturing segment according to the geomechanical similarity term and the segment length penalty term;
solve the objective function by using a dynamic programming algorithm to determine a segmentation point of the fracturing segment; and
divide the fracturing segment according to the segmentation point to obtain a fracturing segment division result, wherein the fracturing segment division result comprises a segment label.

15. The apparatus according to claim 10, wherein the processor is further configured to:
determine a geological sweet spot weight according to the geological sweet spot category label in the geological sweet spot evaluation result;
identify the fracturing segment according to the segment label in the fracturing segment division result and impose a constraint on a fracturing cluster within the fracturing segment, so that the fracturing cluster after the constraint is imposed is located within a preset segment depth range;
generate a candidate area according to the geomechanical strength along the horizontal well depth, and generate a candidate cluster from the candidate area;
take a sum of geological sweet spot weights being greater than a preset weight threshold as a first objective, take the geomechanical similarity item being less than a preset variance threshold as a second objective, and take the preset cluster spacing constraint as a constraint condition; and
construct the multi-objective function based on the first objective, the second objective, and the constraint condition.

16. The apparatus according to claim 15, wherein when solving the multi-objective function constructed according to the geological sweet spot evaluation result, the engineering sweet spot evaluation result and the preset cluster spacing constraint, the processor is specifically configured to:
solve the multi-objective function through a multi-objective optimization algorithm, and determine an objective solution result of the multi-objective function from the candidate cluster, and
wherein when performing the well completion optimization design according to the objective solution result of the multi-objective function, the processor is specifically configured to:
take the objective solution result as an objective design scheme of the fracturing cluster in the fracturing segment, and perform the well completion optimization design according to the objective design scheme of the fracturing cluster.

17. A non-transitory computer-readable storage medium, having computer program instructions stored thereon, wherein the computer program instructions, when executed by a processor, implement the steps of the method according to claim 1.
